(19) United States
(12) Patent Application Publication
(10) Pub. No.: US 2026/0332890 A1
(43) Pub. Date: Oct. 22, 2026

(54) METHOD OF EDITING CAMERA SETTINGS AFTER CAPTURE

(71) Applicants: SONY GROUP CORPORATION, Tokyo (JP); Sony Corporation of America, New York, NY (US)

(72) Inventors: Yutong Dai, San Jose, CA (US); Owen Mayer, Oakland, CA (US); Alexander Berestov, San Jose, CA (US); Shohei Noguchi, Yokohama (JP); Jiro Takatori, Yokohama (JP); Toshinori Shimizu, Yokohama (JP)

(21) Appl. No.: 19/574,372

(22) Filed: Mar. 22, 2026

Related U.S. Application Data
(60) Provisional application No. 63/791,858, filed on Apr. 21, 2025.

(51) Int. Cl. H04N 23/667; H04N 23/60; H04N 23/661

(52) U.S. Cl. CPC H04N 23/667; H04N 23/64; H04N 23/661

(57) ABSTRACT

A method of editing camera settings after capture addresses the challenge of parameter settings before shooting and provides more possibilities to captured photos. The method provides a computational photography algorithm to edit camera settings based on burst photography. For example, a photographer captures an image with aperture F1.8 and shutter speed 1/100 and wants an image with appearance at aperture F2.4 afterwards. The method allows the photographer to change the settings without having to reshoot the scene.

### CROSS-REFERENCE TO RELATED APPLICATION(S)

This application claims the benefit of U.S. Provisional Patent Application Ser. No. 63/791,858, filed Apr. 21, 2025, and titled “A METHOD FOR EDITING CAMERA SETTINGS AFTER CAPTURE,” which is hereby incorporated by reference in its entirety for all purposes.

### FIELD OF THE INVENTION

The present invention relates to cameras. More specifically, the present invention relates to camera settings.

### BACKGROUND OF THE INVENTION

Camera setting editing algorithms exist, such as: (1) a rule-based algorithm for focus editing that requires precise alignment of the image stack, relies on color cues, requires longer processing time as the number of pixels increases; (2) an implicit representation algorithm for focus and exposure editing that operates on a per-pixel basis, which restricts the achievable image resolution and is limited to a single scene during both training and inference.

### SUMMARY OF THE INVENTION

A method of editing camera settings after capture addresses the challenge of parameter settings before shooting and provides more possibilities to captured photos. The method provides a computational photography algorithm to edit camera settings based on burst photography. For example, a photographer captures an image with aperture F1.8 and shutter speed 1/100 and wants an image with appearance at aperture F2.4 afterwards. The method allows the photographer to change the settings without having to reshoot the scene.

In one aspect, a method programmed in a non-transitory memory of a device comprises capturing a series of images with a set of initial parameter settings, selecting a set of target parameter settings and outputting an image based on the series of images captured and the set of target parameter settings. A sequence of the series of images is random. Alternatively, a sequence of the series of images is preset and fixed before capture. The sequence is determined by user input. The user input is acquired using a large language model. The sequence is determined by the user input via a language prompt describing a visual quality of the image. The sequence is determined from information from a scene in the series of images. The sequence is determined based on machine learning and artificial intelligence. Alternatively, a sequence of the series of images is adaptive and changes during capture. The initial parameter settings are adjusted to the target parameter settings utilizing a Gaussian Splat implementation. The initial parameter settings are adjusted to the target parameter settings utilizing an implicit representation network implementation. The initial parameter settings are adjusted to the target parameter settings utilizing a deep learning implementation. The set of target parameter settings comprise aperture, focus, shutter speed, ISO, and focal length.

In another aspect, an apparatus comprises a non-transitory memory configured for storing an application, the application configured for: capturing a series of images with a set of initial parameter settings, selecting a set of target parameter settings and outputting an image based on the series of images captured and the set of target parameter settings and a processor configured for processing the application. A sequence of the series of images is random. Alternatively, a sequence of the series of images is preset and fixed before capture. The sequence is determined by user input. The user input is acquired using a large language model. The sequence is determined by the user input via a language prompt describing a visual quality of the image. The sequence is determined from information from a scene in the series of images. The sequence is determined based on machine learning and artificial intelligence. Alternatively, a sequence of the series of images is adaptive and changes during capture. The initial parameter settings are adjusted to the target parameter settings utilizing a Gaussian Splat implementation. The initial parameter settings are adjusted to the target parameter settings utilizing an implicit representation network implementation. The initial parameter settings are adjusted to the target parameter settings utilizing a deep learning implementation. The set of target parameter settings comprise aperture, focus, shutter speed, ISO, and focal length.

In another aspect, a system comprises a first device configured for: capturing a series of images with a set of initial parameter settings, selecting a set of target parameter settings and outputting an image based on the series of images captured and the set of target parameter settings and a second device configured for receiving the image from the first device. A sequence of the series of images is random. Alternatively, a sequence of the series of images is preset and fixed before capture. The sequence is determined by user input. The user input is acquired using a large language model. The sequence is determined by the user input via a language prompt describing a visual quality of the image. The sequence is determined from information from a scene in the series of images. The sequence is determined based on machine learning and artificial intelligence. Alternative, a sequence of the series of images is adaptive and changes during capture. The initial parameter settings are adjusted to the target parameter settings utilizing a Gaussian Splat implementation. The initial parameter settings are adjusted to the target parameter settings utilizing an implicit representation network implementation. The initial parameter settings are adjusted to the target parameter settings utilizing a deep learning implementation. The set of target parameter settings comprise aperture, focus, shutter speed, ISO, and focal length.

### BRIEF DESCRIPTION OF THE DRAWINGS

FIG. 1 shows a camera settings diagram according to some embodiments.

FIG. 2 shows images acquired with various settings according to some embodiments.

FIG. 3 shows a camera settings diagram according to some embodiments.

FIG. 4 shows images acquired with various settings according to some embodiments.

FIG. 5 shows a diagram of an algorithm for editing camera settings according to some embodiments.

FIG. 6 shows a diagram of an algorithm for editing camera settings using Gaussian Splatting (GS) according to some embodiments.

FIG. 7 shows a diagram of an algorithm for editing camera settings using Implicit Representation Network (IRN) according to some embodiments.

FIG. 8 shows a diagram of an algorithm for editing camera settings using Deep Learning (DL) according to some embodiments.

FIG. 9 shows a diagram of a Large Language Model (LLM)-assisted algorithm according to some embodiments.

FIG. 10 shows a flowchart of a sequence capture according to some embodiments.

FIG. 11 shows a block diagram of an exemplary computing device configured to implement the post-capture camera settings editing method according to some embodiments.

### DETAILED DESCRIPTION OF THE PREFERRED EMBODIMENT

A method of editing camera settings after capture addresses the challenge of parameter settings before shooting and provides more possibilities to captured photos. The method provides a computational photography algorithm to edit camera settings based on burst photography. For example, a photographer captures an image with aperture F1.8 and shutter speed 1/100 and wants an image with appearance at aperture F2.4 afterwards. The method allows the photographer to change the settings without having to reshoot the scene.

Deep learning is used by leveraging both low-level color cues and contextual information within the learned algorithm, and it becomes more robust to minor image misalignment. The processing speed can be significantly improved through parallelization and can be extended to support a broader range of camera settings. Moreover, the method offers greater flexibility in terms of resolution and the option of generalization to different scenes.

There are many camera settings that are able to be modified after capture such as focus, aperture, shutter timing, focal length, exposure/shutter speed, ISO and others.

There are computational photography techniques that combine information from multiple images to produce a new image, for example, high-dynamic-range (HDR) images or images with an extended depth-of-field image (via focus stacking). Many cameras have burst shooting capabilities. For example, the Sony Alpha 9 III achieves a burst rate of up to 120 FPS. Burst shooting is used to capture image sequences within a short time. Burst sequences can be used by computational photography algorithms.

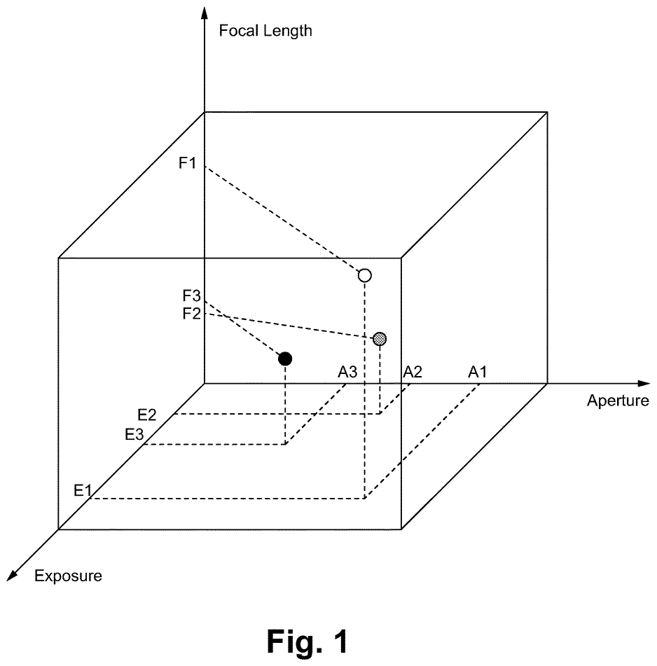

FIG. 1 shows a camera settings diagram according to some embodiments. Camera settings can be viewed as a multi-dimensional space, with each setting representing a dimension. For example, aperture is the x direction, extending outward to denote a wider aperture, exposure is the y direction, extending outward to denote a faster exposure, and focus length is the z direction, extending outward to denote a longer focal length.

When an image of a scene is captured, it uses a combination of camera settings, which can be plotted in this space.

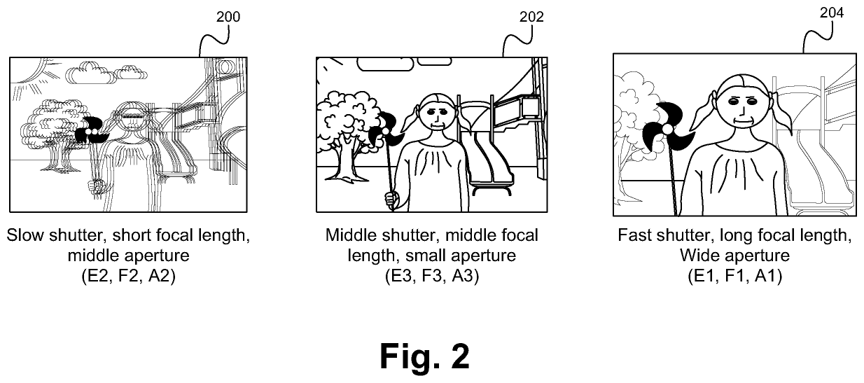

FIG. 2 shows images acquired with various settings according to some embodiments. Image 200 is acquired with a slow shutter, a short focal length, and a middle aperture. Image 202 is acquired with a medium shutter, a medium focal length, and a small aperture. Image 204 is acquired with a fast shutter, a long focal length, and a wide aperture. In cooperation with FIG. 1, the different shutter speeds, focal lengths, and apertures are plotted.

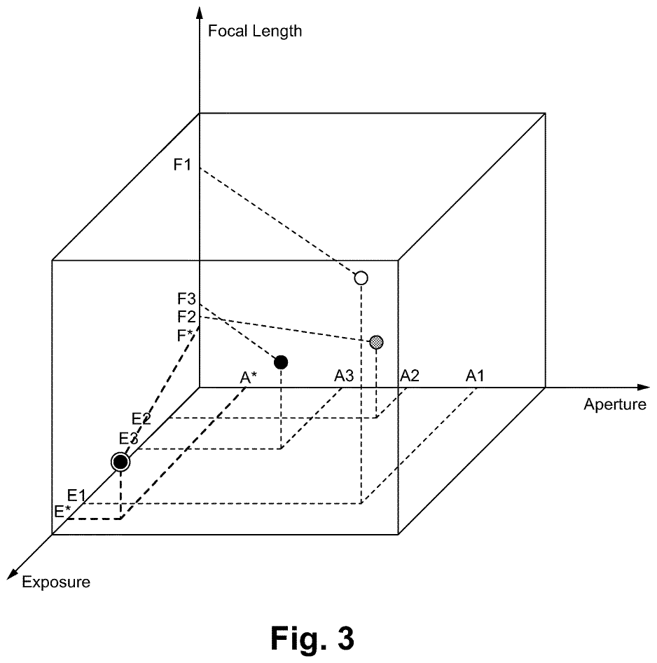

FIG. 3 shows a camera settings diagram according to some embodiments. As described, camera settings can be viewed as a multi-dimensional space, with each setting representing a dimension. E*, F* and A* (shutter speed, focal length and aperture) represent a novel combination of camera parameter settings. Although E*, F* and A* are shown as exemplary camera parameter settings output using the algorithm, any possible combination of camera settings in the multi-dimensional space are able to be output based on previously selected camera settings. Moreover, an image with the corresponding output camera settings is able to be output from one or more captured photographs. Additionally, although the diagram shows a 3-dimensional representation of the camera settings, any number of dimensions are able to be represented and utilized (e.g., 5 dimensions).

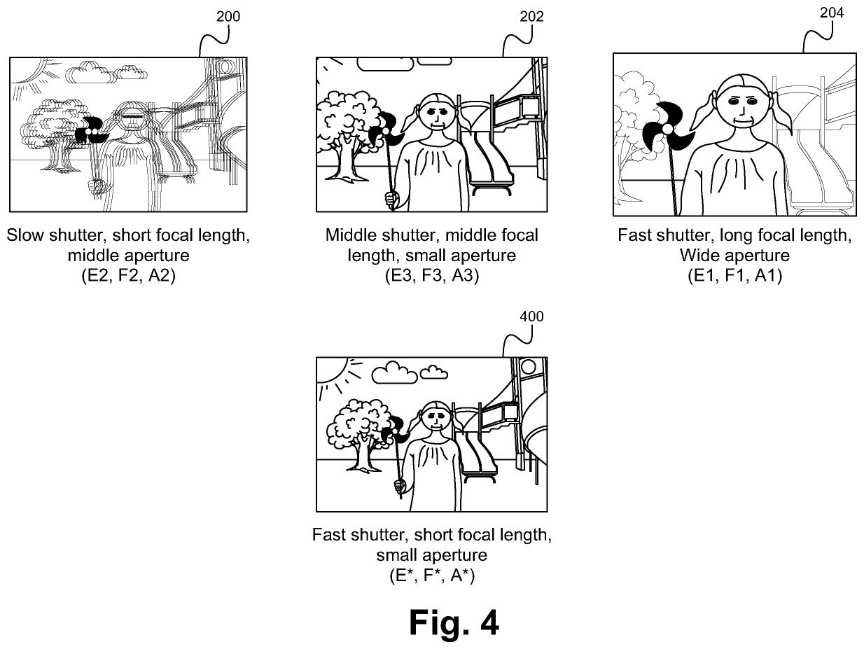

FIG. 4 shows images acquired with various settings according to some embodiments. Image 200 is acquired with a slow shutter, a short focal length, and a middle aperture. Image 202 is acquired with a medium shutter, a medium focal length, and a small aperture. Image 204 is acquired with a fast shutter, a long focal length, and a wide aperture. Image 400 is based on a computational photography algorithm, which takes as input a sequence of images captured under varied camera settings, and outputs a new image with a novel combination of camera parameter settings. In cooperation with FIG. 3, the different shutter speeds, focal lengths, and apertures are plotted.

The post-capture camera settings editing method enables flexible post-capture editing. Typically, parameters such as the focus point or aperture of an image are set before taking the photo. Previously, once the photo is captured, these settings cannot be adjusted.

The post-capture camera settings editing method enables a post-capture editing function that allows photographers to adjust the parameters after the photo has been taken. The feature extends to various camera settings, providing added convenience and flexibility in photography.

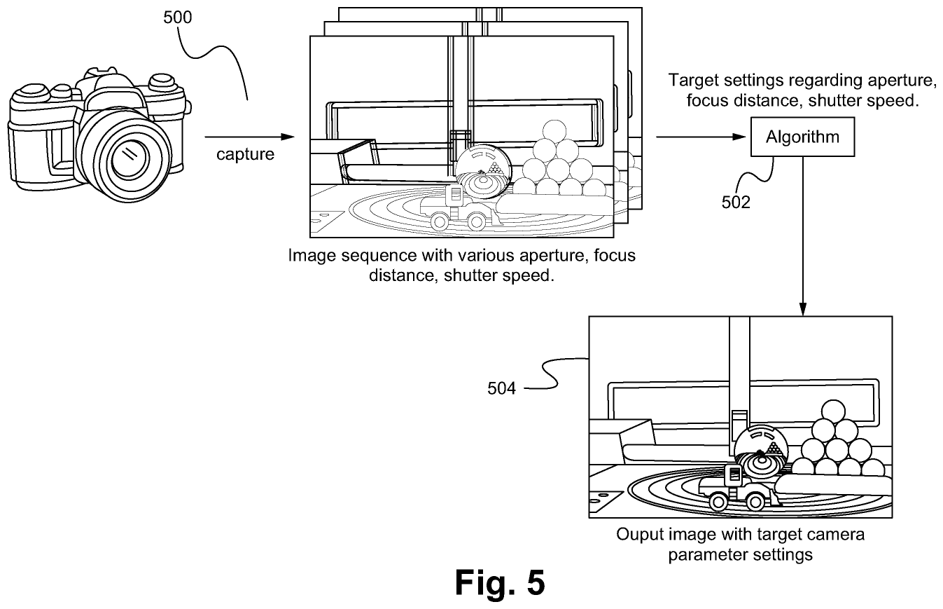

FIG. 5 shows a diagram of an algorithm for editing camera settings according to some embodiments. In the step 500, an image sequence is captured by a device (e.g., camera) under various parameter settings (e.g., aperture, focus distance, shutter speed, ISO, and others). For example, the image sequence is captured using burst photography, where the camera parameter settings are modified for each image in the image sequence. In the step 502, the sequence, along with the target settings, is then provided to the algorithm. The images and settings are processed and used to train the algorithm (e.g., to train a model via machine learning). Then, with the trained model and the target settings, the algorithm produces an edited image that aligns with the specified novel target settings. In the step 504, the image with the target camera parameter settings is output. In some embodiments, fewer or additional steps are implemented. In some embodiments, the order of the steps is modified.

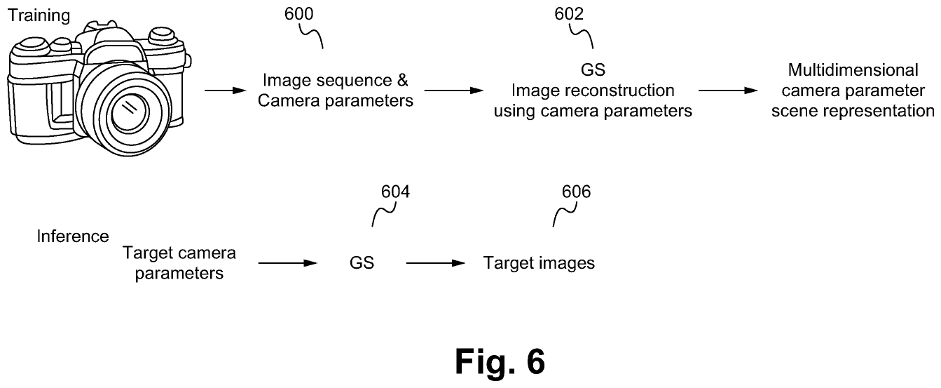

FIG. 6 shows a diagram of an algorithm for editing camera settings using Gaussian Splatting (GS) according to some embodiments. GS is an advanced technique for scene representation and rendering. GS involves learning a camera parameter space representation from images captured at various camera settings. Instead of relying on traditional mesh-based or volumetric representations, the scene is modeled as a collection of learned Gaussians, which can then be used to synthesize novel views from any camera parameter setting given the corresponding camera settings. In the algorithm described herein, the Gaussians are able to be n-dimensional. For example, the first two dimensions are the 2-dimensional image (spatial points), and each camera setting is able to be an added dimension (e.g., aperture is a 3rd dimension, shutter speed is a 4th dimension, and so on).

In the step 600, a specialized burst shooting mode is unitized to capture an image sequence with varying parameter settings with a device (e.g., camera).

In the step 602, the gaussians are optimized by learning to reconstruct each frame within the image sequence. The optimization includes utilizing the images and camera settings to output the Gaussian points. The Gaussian points are used to train a model. Then, the Gaussian points are optimized using machine learning to best represent the camera settings.

After training is complete, in the step 604, the gaussians serve as a representation of the camera parameter space.

In the step 606, images are output using target camera parameters and scene-specific gaussians through rasterizer rendering.

In some embodiments, fewer or additional steps are implemented. In some embodiments, the order of the steps is modified.

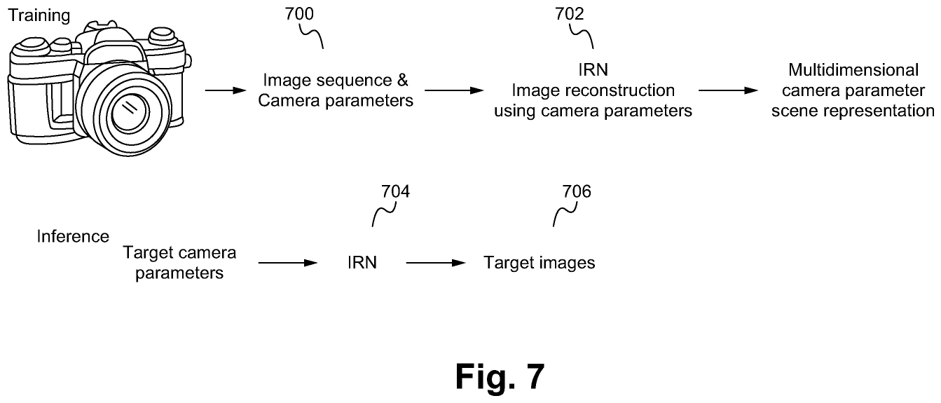

FIG. 7 shows a diagram of an algorithm for editing camera settings using Implicit Representation Network (IRN) according to some embodiments. In the step 700, a specialized burst shooting mode is unitized to capture an image sequence with varying parameter settings with a device (e.g., camera).

In the step 702, the IRN is trained by learning to reconstruct each frame within the image sequence. Each position in an image is able to be represented by n coordinates. For example, the first two coordinates are able to be spatial coordinates (e.g., x, y of a two-dimensional image), z represents the focus position, w represents the aperture, and so on.

After training is complete, in the step 704, the IRN functions as a representation of the camera parameter space for the specific scene, enabling the reconstruction of any camera parameters for the scene that were not encountered during training. For example, for each point of n-dimensions, the x and y points are the spatial coordinates, and the additional coordinates such as z and w are able to be modified to correspond with target camera parameters.

In the step 706, images are output using target camera parameters from the learned scene-specific parameter space.

In some embodiments, fewer or additional steps are implemented. In some embodiments, the order of the steps is modified.

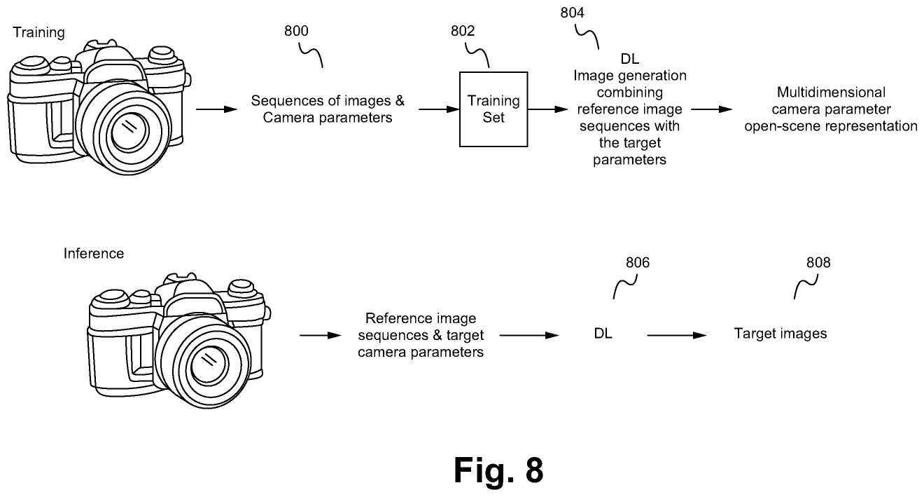

FIG. 8 shows a diagram of an algorithm for editing camera settings using Deep Learning (DL) according to some embodiments. In the step 800, a specialized burst shooting mode is unitized to capture sequences of images with varying parameter settings (real or synthetic) with a device (e.g., camera). In the step 802, a training set is built, with each sample including a reference image sequence, target camera parameters, and corresponding ground truth target images. In the step 804, the DL model is trained to learn the representation through predicting each target image based on the reference sequence and target parameters. In the step 806, the image sequence is captured for application with novel specialized camera parameters. In the step 808, the trained model is applied on the sequence to output images with novel camera parameters. In some embodiments, fewer or additional steps are implemented. In some embodiments, the order of the steps is modified.

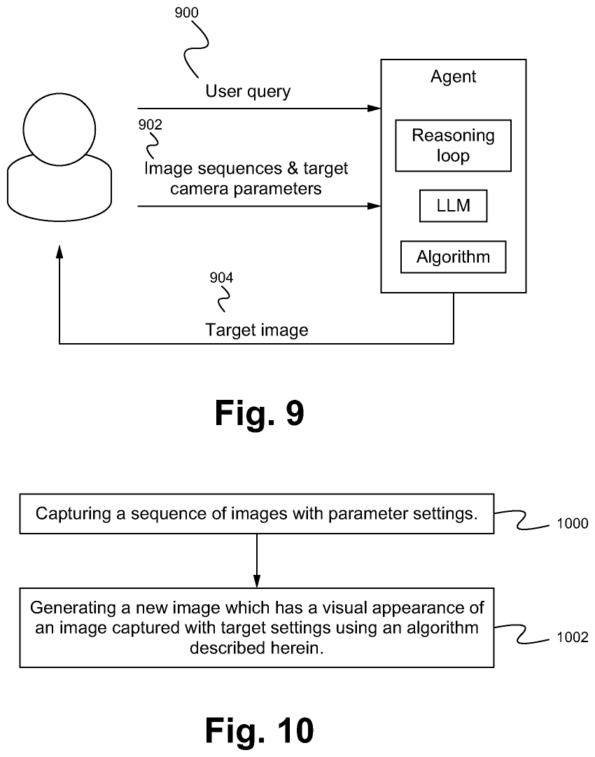

FIG. 9 shows a diagram of a Large Language Model (LLM)-assisted algorithm according to some embodiments. LLMs excel at understanding natural language and outputting responses driven by their reasoning abilities and extensive, internet-scale knowledge. Leveraging this capability, the method supports interactive operation. In the step 900, users provide language-based hints describing the desired parameter settings or target effects. In the step 902, the LLM interprets these hints into novel parameter settings and relays them to an agent connected to the algorithm. In the step 904, one of the algorithms described herein (e.g., GS, IRN, DL) is executed to output images with specialized novel parameters.

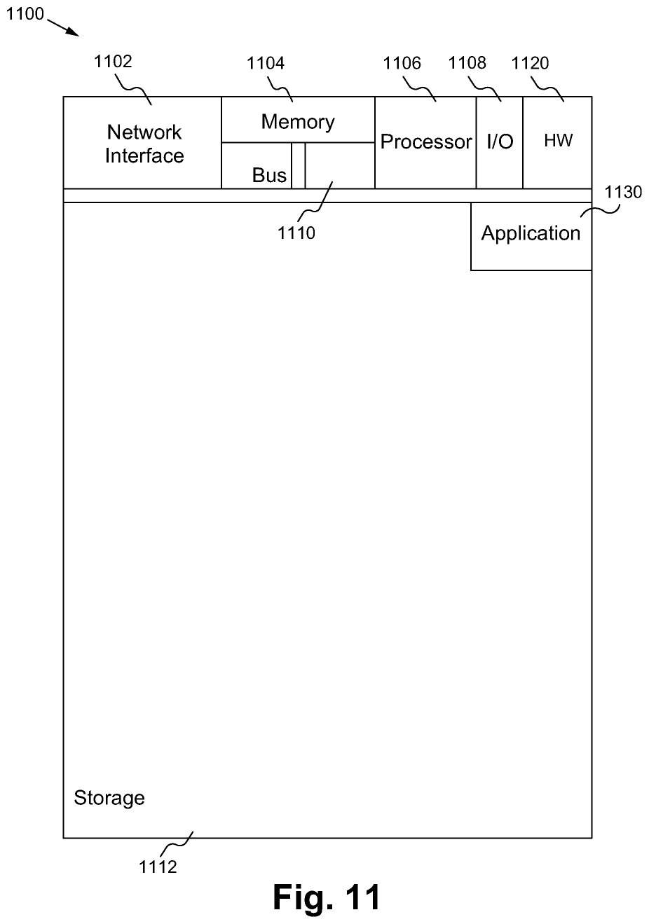

FIG. 10 shows a flowchart of a sequence capture according to some embodiments. In the step 1000, a sequence of N images I¹, I², I³ . . . . I^{N} is captured with parameter settings s¹, s², s³ . . . s^{N}. sⁱ is a vector representing the camera settings of the i^{th} image:

$${s}^{i} = [ {s}_{aperture}^{i} , {s}_{focus}^{i} , {s}_{shutter}^{i} , … ]$$

where

$${s}_{k}^{i}$$

is the value of the kth camera setting (e.g. aperture, focus position, focal length, and others) of the ith image.

In the step 1002, a new image I* which has the visual appearance of an image captured using settings s* is output utilizing an algorithm described herein.

In some embodiments, fewer or additional steps are implemented. In some embodiments, the order of the steps is modified.

In some embodiments, the sequence [s¹, s², s³ . . . s^{N}] is random.

In some embodiments, the sequence [s¹, s², s³ . . . s^{N}] is preset and fixed before capture. For example, the sequence [s¹, s², s³ . . . s^{N}] is determined by user input, indicating a range of values s* might take. In another example, the sequence [s¹, s², s³ . . . s^{N}] is determined by user input via a language prompt describing the visual quality of I*. In another example, the sequence [s¹, s², s³ . . . s^{N}] is determined from information from the scene, such as an image pre-captured, depth or range information, and/or by audio information. In another example, the sequence [s¹, s², s³ . . . s^{N}] is determined based user commands acquired and used in conjunction with an LLM. In another example, the sequence [s¹, s², s³ . . . s^{N}] is determined using machine learning and artificial intelligence.

In some embodiments, the sequence [s¹, s², s³ . . . s^{N}] is adaptive and changes during capture. For example, the vectors s′ for i>1 change after the image I¹ is acquired using settings s¹. In another example, the sequence [s¹, s², s³ . . . s^{N}] is first captured in a preset model, then automatically adjusted via information from user input or from the scene. Some of the sⁱ might be replaced by new captures after adjustment.

In some embodiments, any combination of the sequence being random, being preset and fixed before capture or being adaptive and changes during capture.

In some embodiments, the algorithm produces a new image I*with settings s*, where

$${s}_{k}^{*} > {min}_{i} ( {s}_{k}^{i} ) \& where {s}_{k}^{*} < {max}_{i} ( {s}_{k}^{i} )$$

for all settings k (interpolation).

In some embodiments, the algorithm produces a new image I*with settings s*, where

$${s}_{k}^{*} < {min}_{i} ( {s}_{k}^{i} ) and / or where {s}_{k}^{*} > {max}_{i} ( {s}_{k}^{i} )$$

for at least one setting k (extrapolation).

FIG. 11 shows a block diagram of an exemplary computing device configured to implement the post-capture camera settings editing method according to some embodiments. The computing device 1100 is able to be used to acquire, store, compute, process, communicate and/or display information. The computing device 1100 is able to implement any of the aspects of the method described herein. In general, a hardware structure suitable for implementing the computing device 1100 includes a network interface 1102, a memory 1104, a processor 1106, I/O device(s) 1108, a bus 1110 and a storage device 1112. The choice of processor is not critical as long as a suitable processor with sufficient speed is chosen. The memory 1104 is able to be any conventional computer memory known in the art. The storage device 1112 is able to include a hard drive, CDROM, CDRW, DVD, DVDRW, High Definition disc/drive, ultra-HD drive, flash memory card or any other storage device. The computing device 1100 is able to include one or more network interfaces 1102. An example of a network interface includes a network card connected to an Ethernet or other type of LAN. The I/O device(s) 1108 are able to include one or more of the following: keyboard, mouse, monitor, screen, printer, modem, touchscreen, button interface and other devices. Post-capture camera settings editing application(s) 1130 used to implement the post-capture camera settings editing method are likely to be stored in the storage device 1112 and memory 1104 and processed as applications are typically processed. More or fewer components shown in FIG. 11 are able to be included in the computing device 1100. In some embodiments, post-capture camera settings editing hardware 1120 is included. Although the computing device 1100 in FIG. 11 includes applications 1130 and hardware 1120 for the post-capture camera settings editing method, the post-capture camera settings editing method is able to be implemented on a computing device in hardware, firmware, software or any combination thereof. For example, in some embodiments, the post-capture camera settings editing applications 1130 are programmed in a memory and executed using a processor. In another example, in some embodiments, the post-capture camera settings editing hardware 1120 is programmed hardware logic including gates specifically designed to implement the post-capture camera settings editing method.

In some embodiments, the post-capture camera settings editing application(s) 1130 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

To utilize the post-capture camera settings editing method described herein, a device is used to acquire content. The post-capture camera settings editing method is able to be implemented with user involvement or automatically without user involvement.

In operation, the method includes an algorithm for post-capture editing of camera parameter settings, which takes as input a sequence of images captured under varied camera settings and outputs a new image with a novel combination of camera parameter settings. The method is based on computational photography, camera burst shooting, scene representation, and deep learning.

By integrating the method directly into the camera body, a “smart camera” enables real-time post-capture editing.

A more advanced approach involves combining this technology with the latest Large Language Model (LLM)/Vision Language Model (VLM) tools to interpret both language and visual cues, suggest relevant post-capture editing operations, and automatically carry them out, resulting in a seamless and intuitive editing experience. For example, a user is able to say, “focus on the tree in the middle” or “emphasize the speed of the water's flow.” Then, the method utilized object recognition to determine the tree or the water in the image, and then adjusts the appropriate settings (e.g., focus such that it is on the tree or shutter speed for the water) such that an image with the desired settings is output.

Virtual production is able to be used to output real-time graphics for live broadcasts. It works by blending a pre-production background and a live capture to output a final output. When the background and live capture are captured under different camera settings, the blended output will appear unnatural. Backgrounds captured and adjusted using the method will allow the background image camera settings to match the live capture, improving the overall quality of the virtual production.

Some Embodiments of Method of Editing Camera Settings after Capture
1. A method programmed in a non-transitory memory of a device comprising:
   capturing a series of images with a set of initial parameter settings;
   selecting a set of target parameter settings; and outputting an image based on the series of images captured and the set of target parameter settings.
2. The method of clause 1 wherein a sequence of the series of images is random.
3. The method of clause 1 wherein a sequence of the series of images is preset and fixed before capture.
4. The method of clause 3 wherein the sequence is determined by user input.
5. The method of clause 4 wherein the user input is acquired using a large language model.
6. The method of clause 5 wherein the sequence is determined by the user input via a language prompt describing a visual quality of the image.
7. The method of clause 3 wherein the sequence is determined from information from a scene in the series of images.
8. The method of clause 3 wherein the sequence is determined based on machine learning and artificial intelligence.
9. The method of clause 1 wherein a sequence of the series of images is adaptive and changes during capture.
10. The method of clause 1 wherein the initial parameter settings are adjusted to the target parameter settings utilizing a Gaussian Splat implementation.
11. The method of clause 1 wherein the initial parameter settings are adjusted to the target parameter settings utilizing an implicit representation network implementation.
12. The method of clause 1 wherein the initial parameter settings are adjusted to the target parameter settings utilizing a deep learning implementation.
13. The method of clause 1 wherein the set of target parameter settings comprise aperture, focus, shutter speed, ISO, and focal length.
14. An apparatus comprising:
   a non-transitory memory configured for storing an application, the application configured for:
      capturing a series of images with a set of initial parameter settings;
      selecting a set of target parameter settings; and
      outputting an image based on the series of images captured and the set of target parameter settings; and
   a processor configured for processing the application.
15. The apparatus of clause 14 wherein a sequence of the series of images is random.
16. The apparatus of clause 14 wherein a sequence of the series of images is preset and fixed before capture.
17. The apparatus of clause 16 wherein the sequence is determined by user input.
18. The apparatus of clause 17 wherein the user input is acquired using a large language model.
19. The apparatus of clause 18 wherein the sequence is determined by the user input via a language prompt describing a visual quality of the image.
20. The apparatus of clause 16 wherein the sequence is determined from information from a scene in the series of images.
21. The apparatus of clause 16 wherein the sequence is determined based on machine learning and artificial intelligence.
22. The apparatus of clause 14 wherein a sequence of the series of images is adaptive and changes during capture.
23. The apparatus of clause 14 wherein the initial parameter settings are adjusted to the target parameter settings utilizing a Gaussian Splat implementation.
24. The apparatus of clause 14 wherein the initial parameter settings are adjusted to the target parameter settings utilizing an implicit representation network implementation.
25. The apparatus of clause 14 wherein the initial parameter settings are adjusted to the target parameter settings utilizing a deep learning implementation.
26. The apparatus of clause 14 wherein the set of target parameter settings comprise aperture, focus, shutter speed, ISO, and focal length.
27. A system comprising:
   a first device configured for:
      capturing a series of images with a set of initial parameter settings;
      selecting a set of target parameter settings; and
      outputting an image based on the series of images captured and the set of target parameter settings; and
   a second device configured for receiving the image from the first device.
28. The system of clause 27 wherein a sequence of the series of images is random.
29. The system of clause 27 wherein a sequence of the series of images is preset and fixed before capture.
30. The system of clause 29 wherein the sequence is determined by user input.
31. The system of clause 30 wherein the user input is acquired using a large language model.
32. The system of clause 31 wherein the sequence is determined by the user input via a language prompt describing a visual quality of the image.
33. The system of clause 29 wherein the sequence is determined from information from a scene in the series of images.
34. The system of clause 29 wherein the sequence is determined based on machine learning and artificial intelligence.
35. The system of clause 27 wherein a sequence of the series of images is adaptive and changes during capture.
36. The system of clause 27 wherein the initial parameter settings are adjusted to the target parameter settings utilizing a Gaussian Splat implementation.
37. The system of clause 27 wherein the initial parameter settings are adjusted to the target parameter settings utilizing an implicit representation network implementation.
38. The system of clause 27 wherein the initial parameter settings are adjusted to the target parameter settings utilizing a deep learning implementation.
39. The system of clause 27 wherein the set of target parameter settings comprise aperture, focus, shutter speed, ISO, and focal length.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
capturing a series of images with a set of initial parameter settings;
selecting a set of target parameter settings; and
outputting an image based on the series of images captured and the set of target parameter settings.

2. The method of claim 1 wherein a sequence of the series of images is random.

3. The method of claim 1 wherein a sequence of the series of images is preset and fixed before capture.

4. The method of claim 3 wherein the sequence is determined by user input.

5. The method of claim 4 wherein the user input is acquired using a large language model.

6. The method of claim 5 wherein the sequence is determined by the user input via a language prompt describing a visual quality of the image.

7. The method of claim 3 wherein the sequence is determined from information from a scene in the series of images.

8. The method of claim 3 wherein the sequence is determined based on machine learning and artificial intelligence.

9. The method of claim 1 wherein a sequence of the series of images is adaptive and changes during capture.

10. The method of claim 1 wherein the initial parameter settings are adjusted to the target parameter settings utilizing a Gaussian Splat implementation.

11. The method of claim 1 wherein the initial parameter settings are adjusted to the target parameter settings utilizing an implicit representation network implementation.

12. The method of claim 1 wherein the initial parameter settings are adjusted to the target parameter settings utilizing a deep learning implementation.

13. The method of claim 1 wherein the set of target parameter settings comprise aperture, focus, shutter speed, ISO, and focal length.

14. An apparatus comprising:
a non-transitory memory configured for storing an application, the application configured for:
capturing a series of images with a set of initial parameter settings;
selecting a set of target parameter settings; and
outputting an image based on the series of images captured and the set of target parameter settings; and
a processor configured for processing the application.

15. The apparatus of claim 14 wherein a sequence of the series of images is random.

16. The apparatus of claim 14 wherein a sequence of the series of images is preset and fixed before capture.

17. The apparatus of claim 16 wherein the sequence is determined by user input.

18. The apparatus of claim 17 wherein the user input is acquired using a large language model.

19. The apparatus of claim 18 wherein the sequence is determined by the user input via a language prompt describing a visual quality of the image.

20. The apparatus of claim 16 wherein the sequence is determined from information from a scene in the series of images.

21. The apparatus of claim 16 wherein the sequence is determined based on machine learning and artificial intelligence.

22. The apparatus of claim 14 wherein a sequence of the series of images is adaptive and changes during capture.

23. The apparatus of claim 14 wherein the initial parameter settings are adjusted to the target parameter settings utilizing a Gaussian Splat implementation.

24. The apparatus of claim 14 wherein the initial parameter settings are adjusted to the target parameter settings utilizing an implicit representation network implementation.

25. The apparatus of claim 14 wherein the initial parameter settings are adjusted to the target parameter settings utilizing a deep learning implementation.

26. The apparatus of claim 14 wherein the set of target parameter settings comprise aperture, focus, shutter speed, ISO, and focal length.

27. A system comprising:
a first device configured for:
capturing a series of images with a set of initial parameter settings;
selecting a set of target parameter settings; and
outputting an image based on the series of images captured and the set of target parameter settings; and
a second device configured for receiving the image from the first device.

28. The system of claim 27 wherein a sequence of the series of images is random.

29. The system of claim 27 wherein a sequence of the series of images is preset and fixed before capture.

30. The system of claim 29 wherein the sequence is determined by user input.

31. The system of claim 30 wherein the user input is acquired using a large language model.

32. The system of claim 31 wherein the sequence is determined by the user input via a language prompt describing a visual quality of the image.

33. The system of claim 29 wherein the sequence is determined from information from a scene in the series of images.

34. The system of claim 29 wherein the sequence is determined based on machine learning and artificial intelligence.

35. The system of claim 27 wherein a sequence of the series of images is adaptive and changes during capture.

36. The system of claim 27 wherein the initial parameter settings are adjusted to the target parameter settings utilizing a Gaussian Splat implementation.

37. The system of claim 27 wherein the initial parameter settings are adjusted to the target parameter settings utilizing an implicit representation network implementation.

38. The system of claim 27 wherein the initial parameter settings are adjusted to the target parameter settings utilizing a deep learning implementation.

39. The system of claim 27 wherein the set of target parameter settings comprise aperture, focus, shutter speed, ISO, and focal length.
